(19) United States
(12) Patent Application Publication
(10) Pub. No.: US 2022/0140302 A1
(43) Pub. Date: May 5, 2022

(54) ELECTRODE FOR LITHIUM-ION SECONDARY BATTERY AND METHOD OF MANUFACTURING ELECTRODE FOR LITHIUM-ION SECONDARY BATTERY

(71) Applicant: HONDA MOTOR CO., LTD., Tokyo (JP)

(72) Inventors: Masahiro OHTA, Saitama (JP); Takuya TANIUCHI, Saitama (JP)

(21) Appl. No.: 17/453,175

(22) Filed: Nov. 1, 2021

(30) Foreign Application Priority Data
Nov. 4, 2020 (JP) 2020-184203

(51) Int. Cl. H01M 4/04; H01M 4/13; H01M 4/36; H01M 10/0525

(52) U.S. Cl. CPC H01M 4/0404; H01M 4/13; H01M 2004/021; H01M 10/0525; H01M 4/366

(57) ABSTRACT

To provide an electrode for a lithium-ion secondary battery that can reduce risk of a short circuit when a porous metal is used as a current collector.

An electrode for lithium-ion secondary battery having a positive electrode, a negative electrode, and an electrolyte disposed between the positive electrode and the negative electrode, the electrode comprising a current collector and a current collector tab, wherein the current collector is constituted by a metal porous body having voids in communication with each other, wherein a surface of the current, collector, including surfaces of the voids, is covered with an ion conductor layer, and wherein an electrode active material is disposed on the surface of the ion conductor layer of the voids.

This application is based on and claims the benefit of priority from Japanese Patent Application No. 2020-184203, filed on 4 Nov. 2020, the content of which is incorporated herein by reference.

### BACKGROUND OF THE INVENTION

### Field of the Invention

The present invention relates to an electrode for lithium-ion secondary battery and a method for manufacturing the electrode for lithium-ion secondary battery.

### Related Art

Conventionally, lithium-ion secondary batteries have been widely used as secondary batteries with high energy density. A lithium-ion secondary battery has a structure in which a separator exists between the positive and negative electrodes and is filled with a liquid electrolyte (electrolytic solution).

As a method for increasing packing density of an electrode active material, it has been proposed to use a porous metal as a current collector constituting the positive and negative electrode layers (see, for example, Patent Document 1). Porous metals have a mesh structure with pores and have a large surface area.

An amount of the electrode active material per unit area of an electrode layer can be increased by filling the interior of the mesh structure with an electrode material mixture containing an electrode active material.

Patent Document 1: Japanese Unexamined Patent Application, Publication No. 2012-186135

### SUMMARY OF THE INVENTION

A surface of the porous metal consists of a porous portion and a metallic portion.

In the above-described conventional technology, for example, when the volume of a ceil expanded while the cell was constrained and pressure was applied to the porous metal, stress concentrated on the metal part, resulting in the metal part breaking through the electrolyte layer and causing a short circuit, which was a problem.

The present invention was made in view of the above problem, and it is an object of the present invention to provide an electrode for lithium-ion secondary battery which can reduce the risk of a short circuit when a porous metal is used as a current collector.

A first aspect of the present invention relates to an electrode for lithium-ion secondary battery having a positive electrode, a negative electrode, and an electrolyte disposed between the positive electrode and the negative electrode, the electrode having a current collector and a current collector tab,

in which the current collector is constituted by a metal porous body having voids in communication with each other, in which a surface of the current collector, including surfaces of the voids, is coated with an ion conductor layer, and in which an electrode active material is disposed on the surface of the ion conductor layer in the voids.

According to invention of the first aspect, when a porous metal is used as the current collector, it is possible to provide an electrode for lithium-ion secondary battery by which the risk of a short circuit can be reduced.

A second aspect of the present invention relates to the electrode for lithium-ion secondary battery as described in the first aspect, in which the ion conductor layer has a lower ion conductivity than the electrolyte.

According to the second aspect, it is possible to prevent lithium ions from passing through the ion conductor layer C to increase an ion conduction distance, thereby maintaining battery performance.

A third aspect of the present invention relates to the electrode for lithium-ion secondary battery as described in the first or second aspect, in which at least a part of the surface of the current collector tab is coated with the ion conductor layer.

According to the third aspect, a short circuit caused by the current collector tab can be prevented.

A fourth aspect of the present invention relates to a method for manufacturing an electrode for lithium-ion secondary battery, the method including: an ion conductor layer forming step of coating a surface of a metal porous body as a current collector with an ion conductor, the metal porous body having voids in communication with each other; and an electrode active material filling step of filling the voids with an electrode active material, in which the electrode active material filling step is performed after the ion conductor layer forming step.

According to invention of the fourth aspect, using a porous metal as the current collector, it is possible to provide an electrode for lithium-ion secondary battery in which the risk of a short circuit can be reduced.

A fifth aspect of the present invention relates to a lithium-ion secondary battery, including a positive electrode and a negative electrode, in which at least one of the positive electrode and the negative electrode is the electrode for lithium-ion secondary battery as described in any of the first to the third aspects.

According to the invention of the fifth aspect, when a porous metal is used as the current collector, it is possible to provide a lithium-ion secondary battery in which the risk of a short circuit can be reduced.

### BRIEF DESCRIPTION OF THE DRAWINGS

FIG. 1 is a schematic diagram illustrating a cross-section of an electrode in accordance with an embodiment of the present invention;

FIG. 2 is a schematic diagram illustrating a cross-section of a positive electrode, a negative, electrode, and an electrolyte in accordance with an embodiment of the present invention; and

FIG. 3 is an enlarged schematic diagram of a part of FIG. 2.

### DETAILED DESCRIPTION OF THE INVENTION

An embodiment of the present invention will be described below with reference to the drawings.

The present invention is not limited to the description of the following embodiments.

<Electrode for Lithium-Ion Secondary Battery>

The electrode for lithium-ion secondary battery according to the present embodiment has a current collector and a current collector tab, and the current collector is constituted by a metal porous body having voids in communication with each other.

A surface of the current collector, including surfaces of the voids, is coated with an ion conductor layer, and an electrode active material is disposed on the surface of the ion conductor layer.

The electrode for lithium-ion secondary battery according to this embodiment may be applied to positive electrodes, negative electrodes, or both, in lithium-ion secondary batteries.

In the following description, a positive electrode is used as an example, but the same configuration can be applied to a negative electrode.

(Current Collector)

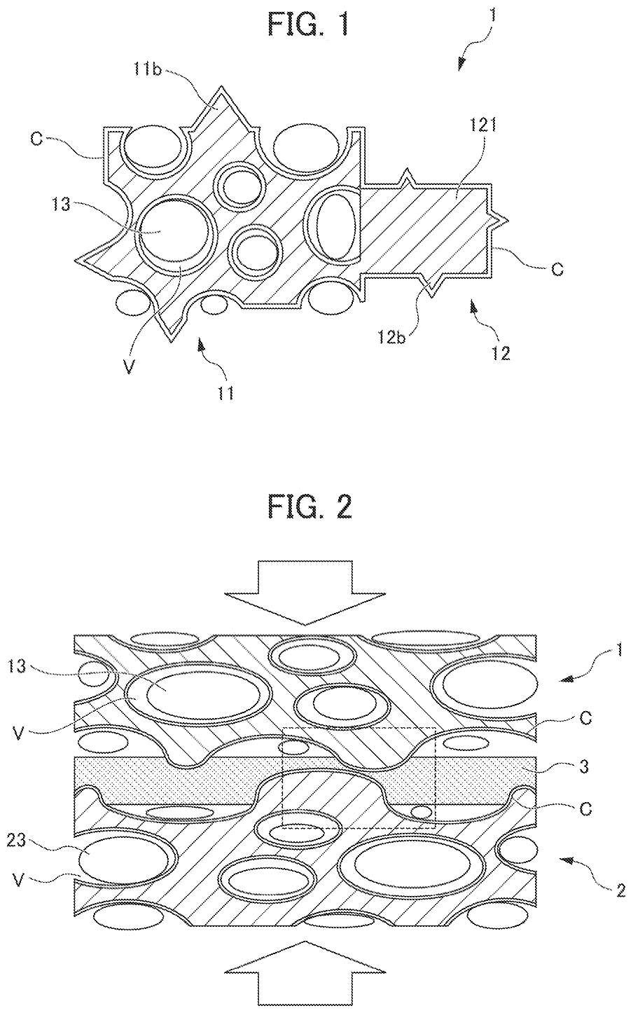

A current collector 11 constituting a positive electrode 1 for lithium-ion secondary battery according to the present embodiment is constituted by a metal porous body having voids V that are in communication with each other, as shown schematically in FIG. 1.

The current collector 11 has voids V that are in communication with each other, whereby it is possible to fill the interior of the voids V with an electrode material mixture containing an electrode active material, thereby increasing an amount of the electrode active material per unit area of the electrode layer.

The metal porous body is not particularly limited as long as it has voids that are in communication with each other, and examples of forms thereof include foamed metal having voids due to foaming, metal mesh, expanded metal, perforated metal, metal nonwoven fabric, and the like.

The metal used for the metal porous body is not particularly limited as long as it has electrical conductivity, but for example, nickel, aluminum, stainless steel, titanium, copper, silver, and the like may be mentioned.

Among these, foamed aluminum, foamed nickel and foamed stainless steel are preferred as a current collector constituting the positive electrode, and foamed copper and foamed stainless steel are preferably used as a current collector constituting the negative electrode.

The current collector 11, which is a metal porous body, has voids V that are in communication with each other, in the inside thereof and has a larger surface area than conventional current collectors, which are metal foil.

By using the above-described metal porous body as the current collector 11, as shown in FIG. 1, the interior of the above-described voids V can be filled with a positive electrode material mixture 13 containing a positive electrode active material.

Thereby, an amount of active material per unit area of the electrode layer can be increased, and as a result, the volumetric energy density of the lithium-ion secondary battery can be improved.

In addition, since the positive electrode material mixture 13 can be easily immobilized, it is unnecessary to thicken a coating slurry to form the electrode material mixture layer, when making the electrode material mixture layer thicker, unlike conventional electrodes in which a metal foil is used as the current collector.

Therefore, an amount of a binder such as an organic polymer compound, etc. that were necessary for thickening can be reduced.

Therefore, the capacity per unit area of the electrode can be increased, and a higher capacity of the lithium-ion secondary battery can be achieved.

(Ion Conductor Layer)

A surface of the current collector 11 is coated with the ion conductor layer C.

The ion conductor layer C is a layer having ion conductivity and an electrically insulating property.

Materials for forming such an ion conductor layer c are not particularly limited, and examples thereof include known ion conductors such as a solid electrolyte, a polymer electrolyte, a gel electrolyte, etc. which are used as an electrolyte to be described below.

Ion conductivity of the ion conductor layer C is preferably lower than that of the electrolyte described below. Thereby, even when the surface of the current collector 11 is coated with the ion conductor layer C, lithium ions are preferentially conducted via the electrolyte.

This can prevent lithium ions from passing through the ion conductor layer C to increase the ion conduction distance. Therefore, the battery performance can be maintained. Since the ion conductivity of the electrolyte at 25° C. is 0.1 to 15 mS/cm, the conductivity of the ion conductor layer C is preferably 0.1 mS/cm or less.

A thickness of the ion conductor layer C is preferably thicker than 20 nm and smaller than the thickness of the electrolyte to be described below.

This provides a sufficient short-circuit protection effect and ensures ion conductivity.

In view of the above, the thickness of the ion conductor layer C is preferably 20 to 100 nm.

Since the current collector 11 has voids V inside, a protrusion portion 11b is formed on the surface when the current collector 11 is cut into a predetermined shape.

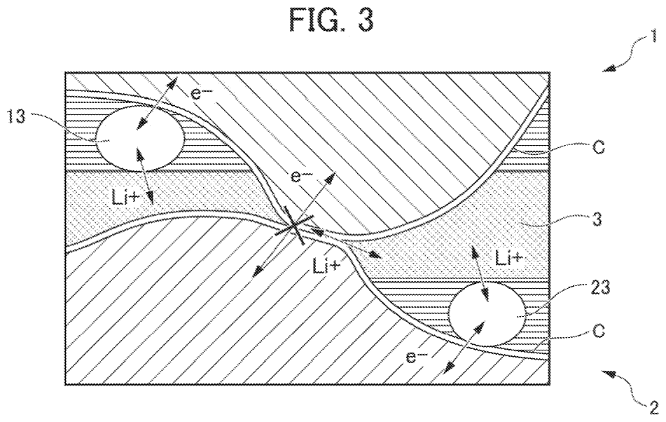

In a conventional current collector, when stress is applied to the current collector from the outside, the stress concentrates on the protrusion part, which may bring the protrusion part into contact with, for example, the conductive part of another electrode, resulting in a short circuit. Explanation will be given below by reference to FIGS. 2 and 3 illustrating a lithium-ion secondary battery having the positive electrode 1, a negative electrode 2, and a solid electrolyte 3 disposed between the positive electrode 1 and the negative electrode 2.

FIGS. 2 and 3 are schematical drawings each illustrating a state in which protrusion portions on the current collector surfaces of the positive electrode 1 and the negative electrode 2 break through the solid electrolyte 3 and contact each other.

For example, as shown by arrows in FIG. 2, when pressure molding is performed from the stacking direction or when constraint pressure is applied, the protrusion portions of the positive electrode 1 and the negative electrode 2 may break through the solid electrolyte 3 and contact each other.

A surface of the current collector of the electrode for lithium-ion secondary battery of the present embodiment, including surfaces of the voids V, is coated with the ion conductor layer C.

This prevents short-circuits in the event of the above situation.

In FIGS. 2 and 3, the positive electrode 1 and the negative electrode 2 as electrodes are both formed having a current collector which is a metal porous body.

All of the current collectors have voids V that are in communication with each other, inside the current collectors. On the surface of the voids V, the ion conductor layer C is formed.

On the surface of the ion conductor layer C in the inside of the voids V, the positive electrode material mixture 13 and a negative electrode material mixture 23 having a positive electrode active material and a negative electrode active material, respectively, are disposed.

FIG. 3 is an enlarged view of an area enclosed by dotted lines in FIG. 2.

As shown in FIG. 3, even when a protrusion portion of the current collector of the positive electrode 1 and a protrusion portion of the current collector of the negative electrode 2 come into contact with each other, the surfaces of the current collectors of the positive electrode 1 and the negative electrode 2 are covered with the ion conductor layer C, so that flow of electrons e⁻ is hindered.

As a result, the thickness of the ion conductor layer c doubles, as the ion conductor layers C contact each other.

In addition to the above, the thickness does not easily vary even by pressing the electrodes or applying constraint pressure to the electrodes.

Therefore, electrons e⁻ are not easily transferred due to a tunneling effect.

This prevents occurrence of short circuits.

On the other hand, since the ion conductor layer C has ion conductivity, even when the protrusion portion of the current collector of the positive electrode 1 and the protrusion portion of the current collector of the negative electrode 2 contact each other by breaking through the solid electrolyte 3, flow of lithium ions Li⁺ is not hindered.

Furthermore, flow of electrons e⁻ between the positive electrode material mixture 23 and a positive electrode current collector and flow of electrons e⁻ between the negative electrode material mixture 23 and a negative electrode current collector are ensured by transfer of electrons e⁻ through a conductive aid contained in each of the positive electrode material mixture 13 and the negative electrode material mixture 23, which will be described below.

Moreover, as the ion conductor layer C is sufficiently thin, the flow of electrons is ensured by transfer of electrons e⁻ between the positive electrode material mixture 13 and the positive electrode current collector, and between the negative electrode material mixture 23 and the negative electrode current collector due to the tunneling effect.

Additionally, the flow of electrons e⁻ is ensured by contact between a part of the positive electrode material mixture 13 and the positive electrode current collector and contact between a part of the negative electrode material mixture 23 and the negative electrode current collector, as described below.

(Electrode Active Material)

The positive electrode active material and the negative electrode active material are disposed in the voids v formed inside the current collectors, as the positive electrode material mixture 13 and the negative electrode material mixture 23, respectively, which are electrode material mixtures containing, for example, electrode active materials. The electrode material mixture may optionally include components other than the electrode active materials.

The other components are not particularly limited, and can be any components that can be used in manufacturing lithium-ion secondary batteries.

For example, a solid electrolyte, a conductive aid, a binder, and the like may be mentioned.

The positive electrode material mixture 13 and the negative electrode material mixture 23 are disposed in the voids V after the ion conductor layer C is formed.

Thereby, the positive electrode material mixture 13 and the negative electrode material mixture 23 are disposed on the surface of the ion conductor layer C.

Note that in the production of lithium-ion secondary batteries, the electrodes are pressed to reduce voids and improve energy density, and also to secure reaction areas.

For this reason, the positive electrode material mixture 13 and the negative electrode material mixture 23 are disposed so as to be embedded into the ion conductor layer C by the pressure during the above pressing.

Accordingly, a portion of the positive electrode material mixture 13 and a portion of the negative electrode material mixture 23 may be in contact with the positive and negative current collectors, respectively.

The positive electrode active material is not particularly limited to those that can occlude and release lithium ions, and for example, LiCoO₂, Li(Ni_{5/10}Co_{2/10}Mn_{3/10})O₂, Li(Ni_{6/10}CO_{2/10}Mn_{2/10})O₂, Li(Ni_{3/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCcO₄, LiMn₂O₄, LiNiO₂, LiFePO₄, lithium sulfide, sulfur, and the like may be mentioned.

The negative electrode active material is not particularly limited as long as it can occlude and release lithium ions, and examples thereof include metallic lithium, lithium alloys, metal oxides, metal sulfides, metal nitrides, Si, SiO, and carbon materials such as artificial graphite, natural graphite, hard carbon, soft carbon, etc.

(Current Collector Tab)

A current collector tab 12 is electrically connected to the current collector 11.

The current collector tab 12 is formed, for example, by extending a portion of the current collector 11.

The current collector tab 12 is formed, for example, by compressing an end of the current collector 11, which is a metal porous body having voids V that are in communication with each other.

Therefore, a protrusion portion 12b is formed on the surface of the current collector tab 12, as shown in FIG. 1.

The current collector tab 12 is electrically connected, for example, by welding to a tab lead (not shown) on an upper surface 121 as a welding portion.

The above-described welding portion is sufficient, only if the welding portion is formed at a point in the current collector tab 12, and the location is not limited to the upper surface with respect to the stacking direction, but may also be a lower surface.

A surface of the current collector tab 12 is coated with the ion conductor layer C, except for the upper surface 121 as the welding portion.

As the ion conductor layer c above, the same configuration as that of the ion conductor layer C covering the periphery of the current collector 11 may be applied.

The surface of the current collector tab 12, except for the welding portion, is coated with the ion conductor layer C, whereby even when the current collector tab 12 has the protrusion portion 12b, a short circuit caused by the protrusion portion 12b can be suppressed.

The configuration of the current collector tab 12 described above is equally applicable to both the positive electrode and the negative electrode of the lithium-ion secondary battery.

<Lithium-Ion Secondary Battery>

The lithium-ion secondary battery according to the present embodiment has a positive electrode, a negative electrode, and an electrolyte disposed between the positive electrode and the negative electrode.

In order for a battery to be categorized as a lithium-ion secondary battery of the present embodiment, it is sufficient for at least one of the positive electrode and the negative electrode to be the lithium-ion secondary battery.

(Positive Electrode and Negative Electrode)

In the lithium-ion secondary battery according to the present embodiment, the positive electrode and the negative electrode to which the electrode for lithium-ion secondary battery as described in the present embodiment is not applied are not particularly limited, but may be any electrode that functions as a positive electrode and a negative electrode for lithium-ion secondary batteries.

Any lithium-ion secondary battery can be constituted by selecting two types of materials from materials that can constitute electrodes, comparing the charge-discharge potentials of the two types of materials, and using the one that, shows a noble potential as a positive electrode and the one that shows a low potential as a negative electrode.

(Electrolyte)

A battery to which the electrode for lithium-ion secondary battery as described in the present embodiment can be applied may be provided with an electrolytic solution which is obtained by dissolving an electrolyte in a non-aqueous solvent or with a solid electrolyte, which is a solid or gel electrolyte.

However, in the lithium-ion secondary battery with a solid electrolyte, there is a large risk of a short circuit occurring when the metal part of the metal porous body breaks through the solid electrolyte due to the constraint pressure. The electrode for lithium-ion secondary battery as described in the present embodiment can be more preferably applied to the lithium-ion secondary battery having a solid electrolyte because the above risk can be reduced.

The solid electrolyte is not particularly limited, and examples thereof include a sulfide-based solid electrolyte material, an oxide-based solid electrolyte material, a nitride-based solid electrolyte material, a halide-based solid electrolyte material, etc.

Examples of the sulfide-based solid electrolyte material include LPS-based halogens (Cl, Br, I), Li₂S—P₂S₂, Li₂S—P₂S₅—LiI, etc.

Note that the above description, “Li₂S—P₂S₅”, refers to a sulfide-based solid electrolyte material comprising a raw material composition containing Li₂S and P₂S₅, and this applies likewise to other recitations.

As the oxide-based solid electrolyte material, for example, in the case of the lithium ion battery, a NASICON type oxide, a garnet type oxide, a perovskite type oxide, and the like can be mentioned.

Examples of the NASICON-type oxide include oxides containing Li, Al, Ti, P and O (e.g., Li_{1.5}Al_{0.5}Ti_{1.5}(PO₄)₃).

Examples of the garnet-type oxide include oxides containing Li, La, Zr and O (e.g., Li₇La₃Zr₂O₁₂).

Examples of the perovskite-type oxide include oxides containing Li, La, Ti and O (e.g., LiLaTiO₃).

Electrolytes dissolved in non-aqueous solvents include, but are not limited to, LiPF₆, LiBF₄, LiClO₄, LiN (SO₂CF₃), LiN(SO₂C₂F₅)₂, LiCF₃SO₃, LiC₄F₉SO₃, LiC(SO₂CF₃)₃, LiF, LiCl, LiI, Li₂S, Li₃N, Li₃P, Li₁₀GeP₂S₁₂(LGPS), Li₃PS₄, Li₆PS₅Cl, Li₇P₂S₈I, LiₓPO_{y}Nₓ (x=2y+3z−5, LiPON), Li₇La₃Zr₂O₁₂ (LLZO) , Li₃ₓLa_{2/3-x}TiO₃ (LLTO), Li₁₊ₓAlₓTi₂₋ₓ(PO₄)₃ (0≤x≤1, LATP), Li_{1.5}Al_{0.5}Ge_{1.5}(PO₄)₃ (LAGP), Li_{1+x+y}AlₓTi₂₋ₓSi_{y}P_{3-y}O₁₂, Li_{1+x+y}Alₓ (Ti, Ge)₂₋ₓSi_{y}P_{3-y}O₁₂, Li₄₋₂ₓZnₓGeO₄ (LISICON), and the like.

One of the above may be used alone, or two or more may be used in combination.

The non-aqueous solvent included in the electrolytic solution is not particularly limited, and may include aprotic solvents such as carbonates, esters, ethers, nitriles, sulfones, lactones, etc.

Specifically, ethylene carbonate (EC), propylene carbonate (PC), diethyl carbonate (DEC), dimethyl carbonate (DMC), ethyl methyl carbonate (EMC), 1,2-dimethoxyethane (DME), 1,2-diethoxyethane (DEE), tetrahydrofuran (THF), 2-methyltetrahydrofuran, dioxane, 1,3-dioxolane, diethylene glycol dimethyl ether, ethylene glycol dimethyl ether, acetonitriie (AN), propionitrile, nitromethane, N,N-dimethylformamide (DMF), dimethyl sulfoxide, sulfolane, γ-butyrolactone, and the like.

One of the above may be used alone, or two or more may be used in combination.

(Separator)

The lithium-ion secondary battery as described in the present embodiment may include a separator.

The separator is disposed between the positive and negative electrodes.

Material and thickness of the separator are not particularly limited, and any known separator that can be used for lithium-ion secondary batteries can be applied.

<Manufacturing Method of Electrode for Lithium-Ion Secondary Battery>

A method for manufacturing the electrode for lithium-ion secondary battery as described in the present embodiment includes an ion conductor layer forming step of coating a surface of a metal porous body as a current collector with an ion conductor, the metal porous body having voids in communication with each other; and an electrode active material filling step of filling the voids of the metal porous body with an electrode active material, in which the electrode active material filling step is performed after the ion conductor layer forming step.

(Ion Conductor Layer Forming Step)

A method of coating the surface of the metal porous body, which is a current collector having voids in communication with each other, with an ion conductor to form an ion conductor layer is not particularly limited, and includes, for example, a method of impregnating the inside of the metal porous body with an ion conductor layer by applying pressure using a plunger-type die coater.

In addition to the above, the interior of the metal porous body may be impregnated with the ion conductor layer by a dipping method.

In the ion conductor forming step, the surface of the current collector tab may be coated with the ion conductor layer concurrently with the surface of the current collector.

As a result, it is preferable to coat the current collector tab, etc. with the ion conductor, while masking a part of the upper surface or the like of the current collector tab.

Thereby, it is possible to obtain a part on the current collector tab on which no ion conductor layer is formed, and the above part can be used as a welding portion between the current collector tab and a lead tab.

(Electrode Active Material Filling Step)

After the ion conductor forming step, the electrode active material filling step is performed.

The electrode active material filling step is a step of filling the voids of a metal porous body, which is a current collector, with an electrode material mixture including an electrode active material.

A method of filling the current collector with the electrode material mixture is not particularly limited, and includes, for example, a method of filling the interior of voids of a current, collector with a slurry containing an electrode material mixture by applying pressure using a plunger-type die coater.

Note that combination of methods can be freely performed, such as using a dipping method in the ion conductor layer forming step and using a plunger-type die coater in the electrode active material filling step.

The method for manufacturing electrode for lithium-ion secondary battery according to the present embodiment may include a step other than those described above.

For example, a step of forming a current collector tab may be included, the step including compressing an edge of the metal porous body as a current collector prior to the ion conductor layer forming step.

In addition to the above, other known methods used for manufacturing electrodes for lithium-ion secondary batteries can be applied.

For example, the electrode for lithium-ion secondary battery is obtained by drying the current collector filled with the electrode material mixture, followed by pressing.

The density of the electrode material mixture can be improved by pressing and can be adjusted to achieve a desired density.

Although a preferred embodiment of the present invention has been described above, the content of the present invention is not limited to the above embodiment and can be changed as appropriate.

In the description of FIGS. 2 and 3 in the above embodiment, explanation is based on the assumption that the electrolyte is a solid electrolyte.

The present invention is not limited to the above.

The electrolyte may be an electrolytic solution in which an electrolyte is dissolved in a solvent such as a non-aqueous medium.

### EXPLANATION OF REFERENCE NUMERALS

1 Positive electrode
11 Current collector
12 Current collector tab
13 Positive electrode material mixture (electrode active material)
2 Negative electrode
23 Negative electrode material mixture (electrode active material)
3 solid electrolyte (electrolyte)
C Ion conductor layer
V Void

What is claimed is:

1. An electrode for lithium-ion secondary battery comprising a positive electrode, a negative electrode, and an electrolyte disposed between the positive electrode and the negative electrode,
the electrode comprising a current collector and a current collector tab,
wherein the current collector is constituted by a metal porous body having voids in communication with each other,
wherein a surface of the current collector, including surfaces of the voids, is coated with an ion conductor layer, and
wherein an electrode active material is disposed on a surface of the ion conductor layer in the voids.

2. The electrode for lithium-ion secondary battery according to claim 1, wherein the ion conductor layer has a lower ion conductivity than the electrolyte.

3. The electrode for lithium-ion secondary battery according to claim 1, wherein at least a portion of a surface of the current collector tab is coated with the ion conductor layer.

4. A method for manufacturing an electrode for lithium-ion secondary battery, the method comprising:
an ion conductor layer forming step of coating a surface of a metal porous body as a current collector with an ion conductor,
the metal porous body having voids in communication with each other; and
an electrode active material filling step of filling the voids with an electrode active material,
wherein the electrode active material filling step is performed after the ion conductor layer forming step.

5. A lithium-ion secondary battery, comprising a positive electrode and a negative electrode, wherein at least any one of the positive electrode and the negative electrode is the electrode for lithium-ion secondary battery according to claim 1.
